(19) United States
(12) Patent Application Publication
(10) Pub. No.: US 2007/0091637 A1
(43) Pub. Date: Apr. 26, 2007

(54) Prism sheet, surface light source device and display

(75) Inventors: Fuminori Hiraishi, Urawa-shi (JP); Mamoru Yoshida, Tokorozawa-shi (JP)

Correspondence Address: STAAS & HALSEY LLP, SUITE 700, 1201 NEW YORK AVENUE, N.W., WASHINGTON, DC, 20005, US

(73) Assignee: ENPLAS CORPORATION, Saitama (JP)

(21) Appl. No.: 11/517,403

(22) Filed: Sep. 8, 2006

(30) Foreign Application Priority Data
Sep. 9, 2005 (JP) 261928/2005

(51) Int. Cl. F21V 7/04; F21V 5/00

(52) U.S. Cl. 362/606; 362/620; 362/330

(57) ABSTRACT

White points (point-like abnormal emission) are made scare even if prismatic projection rows of a prism sheet are pressed against an emission face of a light guide plate. A plurality of prismatic projections are formed side by side on an inner face of a prism sheet. Each prismatic projection row has a steep slope for light input and a gentle slope for inner-reflection, the gentle slope being provided with a plurality of fine projections in a predetermined range near to the tip of the prismatic projection row. Fine projections may be ridge-like or dome-like projections. The tips of prismatic projection rows may be diverge to form a plurality of top portions having cross sections like triangles. Even if LCD panel or the like presses the prism sheet partially hard against the emission face of the light guide plate and causes tip portions of the prismatic projection rows to be subject to yield-deformation, conspicuous white points are avoided from appearing because contacting occur at a plurality of scattered parts.

### BACKGROUND

1. Field of Invention

The present invention relates to a prism sheet, surface light source device employing the prism sheet and a display employing the surface light source device. Basically, the present invention provides an improved prism sheet, further bringing improvements, by using the improves prism sheets, in displays employed in personal computers, game machines portable phones or the likes, and in surface light source devices for illuminating display members (such as LCD panel) employed in the displays.

2. Related Arts

It is known well to employ a surface light source device for backlighting display members such as LCD panel in personal computers, game machines portable phones or the likes. Various arts related this have bee proposed.

<Prior Art 1>

FIG. 8 illustrates a prior art for backlighting a LCD panel by a surface light source device. Referring to FIG. 8, surface light source device 100 has light guide plate 101 provided with emission face 102 on which diffusion sheet 104, two prism sheets 105, 106 are arranged as to be piled up. Emission from emission face 102 is gathered as to come near to a normal direction of emission face 102 by two prism sheets 105, 106 after being diffused by diffusion sheet 104, then being supplied to LCD panel 103.

Light supply to light guide plate 101 is done by light source 110 disposed opposite to 108 side face (incidence face) 108 (i.e. parallel to X-axis). Each prism sheet 105, 106 has a great number of prismatic projections 111, 112 each of which is provided with a triangle-like cross section and projects upward in the illustration. Prism sheets 115, 16 are orientated so that prismatic projections 111 and prismatic projections 112 run perpendicularly to each other.

Light guide plate 101 has a major face providing emission face 102 and another major face providing a back face along which a reflection member 107 having generally the same shape as a plane shape of light guide plate 101 is disposed.

Such Prior art 1 involves a problem. Although emission from emission face 102 is gathered as to come near to the normal direction of emission face 102 by prism sheets 105, 106, not a little emission is directed toward useless directions (such as directions out of image viewing angle range) because of undergoing diffusion caused by diffusion sheet 104. In addition, many additional sheets members disposed on emission face 102 make loss of light at their interfaces increased.

<Prior Art 2>

Thus it is required to reduce numbers and diffusion ability of additional sheet members interposed between a light guide plate and LCD panel. To meet this requirement, surface light source device 200 as shown in FIG. 9 has been proposed and used frequently. Referring to FIG. 9, surface light source device 200 200 has light guide plate 201 provided with emission face 202 on which a single prism sheet 203 is disposed. Emission with directivity from emission face 202 is deflected as to come near to a normal direction of emission face 202 (i.e. Z-direction) by prism sheet 203.

Thickness of light guide plate 201 decreases away from incidence face 205 opposite to light source 204 (along Y-direction) for increasing emission efficiency of emission face 202, giving a wedge-like shape to light guide plate 201.

In addition, back face 207 of light guide plate 201 is provided with a plurality of prismatic projections 206 running generally perpendicularly to incidence face 205 (i.e. along Y-direction) for improving directivity of emission from emission face 202. Each prismatic projection 206 has a triangle-like cross section in a plane parallel to incidence face 205. Reflection member 208 is disposed along back face 207.

This arrangement causes inner propagation light of light guide plate 201 to be deflected and provided with directivity, on being reflected at reflection points on slopes of prismatic projections 206, as to come near to YZ-planes passing reflection the reflection points, respectively (See FIG. 9). Such light having directivity is emitted from emission face 202.

Further prism sheet 203 has prismatic projections 210 (projecting downward) formed on a face opposite to light guide plate 201, being different from prism sheets 105, 106 in accordance with Prior Art 1 having prismatic projections 111, 2112 projecting upward.

Then prism sheet 203 is orientated so that prismatic projections 210 run generally in a direction parallel to incidence face 205 of light guide plate 201. This arrangement causes top of each prismatic projections 210 to abut on emission face 202. In the case of Prior Art 2, prismatic projections 210 of prism sheet 203 have the same height and arrayed extremely regularly along the direction generally parallel to incidence face 205.

As a result, each plane passing each top of each prismatic projection 210 provides a pseudo-flat-plane. If emission face 202 is a flat face, two flat planes are located as to abut on each other, with the result that sticking of top(s) of prismatic projection(s) 210 on emission face 210 occurs actually at one or more places. At each sticking place, so-called “white point” appears as a result of direct light guiding from light guide plate 201 to prismatic projection 210. White point is a point-like abnormal emission portion.

<Prior Art 3/Prior Art 4>

Prior Art 3 as shown in FIG. 10 has been proposed in Document 1 below in order to solve such problem caused by sticking. Referring to FIG. 10, prism sheet 203 has prismatic projections 210 height of each of which varies along a longitudinal direction (i.e. X-direction in FIG. 10).

Further, Prior Art 4 as shown in FIG. 11 has been proposed in Document 2 below in order to avoid flat faces from abutting on each other, according to which emission face 202 of light guide plate 201 is formed of a rough surface 212.

However, prism sheet 203 shown in FIG. 10 is apt to be affected by locally strong pinching force because of being interposed between light guide plate 201 and LCD panel 211, with the result that a strong external force tends to be applied concentrated to a large projection-height portion(s). Usually this external acts so that a plurality of portions located along a longitudinal direction of prismatic projections 210 (i.e. large projection-height portions) abut on emission face 202 and are pressed against the same.

If the external force is dispersed along the longitudinal direction of prismatic projections 210, pressing force against emission face 202 applied to prismatic projections 210 corresponding to abutting portions is made slight. However, in the case of Prior Art 3 having projection-height varying along the longitudinal direction, it is difficult to disperse external force as compared with cases where projection-height is constant. Therefore Prior Art 3 is apt to give white points which are produced by a strong force locally pressing prismatic projections 210 against emission face 202.

On the other hand, Prior Art 4 shown in FIG. 1 rough surface 212 formed on emission face 202 causes emission directivity to be reduced. If it is tried to avoid such directivity reduction, state of rough surface 212 must be changed depending on size of emission face 202 or thickness of light guide plate 201, resulting in a problem that degree of freedom in designing light guide plate 201 and in manufacturing molds is reduced.

<Prior Art 5>

A prior art (Prior Art 5) other than the above-describe Prior Arts 1 to 4 is disclosed in Document 3 below. Prior Art 5 also employs a prism sheet having many prismatic projections disposed on an emission face of a light guide plate so that the prismatic projections (projecting portions) project upward. Then the prismatic projections have roughened surfaces, thereby preventing Moire fringes from appearing. This arrangement according to Prior Art 5 involves no idea of downward projecting prismatic projection arrangement.

Therefore Prior Art 5 fails to be directly relevant to the foresaid problem (i.e. emerging of white points caused by mutual abutting or pressing of prismatic projections and emission face) in cases where prismatic projections are arranged downward.

Document 1; Tokuhyo-2002-504698

Document 2; Tokkai-003-167251

Document 3; Tokkai-Hei-6-250182

### OBJECT AND SUMMARY OF INVENTION

An object of the present invention is to provide a prism sheet capable of overcoming the above-described problem arising in cases of downward arrangement of prismatic projections (i.e. white points generated by mutual contact or pressing of prismatic projections and an emission face). Another object of the present invention is to provide a surface light source device with an arrangement of downward prismatic projections which suppresses white points by employing said prism sheet. Still another object of the present invention is to provide a display capable of high quality image displaying by employing said surface light source device.

First, the present invention is applied to a prism sheet used for deflect travelling directions of emission light with directivity from an emission face of a light guide plate as to make the travelling directions near to a normal direction of the emission face by being disposed on the emission face.

The present invention requires the prism sheet to have either first or second basic feature.

According to the first basic feature, said prism sheet has an inner face which is directed to said emission face when the prism sheet is disposed on said emission face, and has an outer face directed oppositely to said inner face, said inner face being provided with a plurality of prismatic projection rows side by side along an extending direction.

In addition, each of said prismatic projection rows is provided with a first slope providing an input surface for said emission light and a second slope providing an inner-reflection surface for light inputted from said first slope, thereby providing a triangle-like cross section perpendicular to said extending direction.

Further, said first slope makes a first angle with respect to said normal direction in said cross section and said second slope makes a second angle, which is larger than said first angle, with respect to said normal direction in said cross section, said second slope being provided with a plurality of fine projections in a predetermined range near to a tip at which said second slope meets said first slope.

It is noted that each of said fine projections preferably has a projecting height falling in a rage from 0.1 to 50 μm. Said fine projections are allowed to have various shapes.

For example. each may be a ridge-like projection running said extending direction. If so shaped, the ridge-like projection may be a fine prismatic projection having a projecting height constant along said extending direction and a triangle-like cross section perpendicular to the extending direction.

Alternatively, each of said fine projections may be a dome-like projection. If so shaped, the dome-like projections may have a constant projecting height.

According to the second basic feature, said prism sheet has an inner face which is directed to said emission face when the prism sheet is disposed on said emission face, and has an outer face directed oppositely to said inner face, said inner face being provided with a plurality of prismatic projection rows side by side along an extending direction.

In addition, each of said prismatic projection rows is provided with a first slope providing an input surface for said emission light and a second slope providing an inner-reflection surface for light inputted from said first slope, thereby providing a triangle-like cross section perpendicular to said extending direction.

Further, each of said prismatic projection rows diverges at a tip of said triangle-like as to provide a plurality of top portions each of which has a triangle-like cross section perpendicular to said extending direction, thereby causing said top portions to be in contact with said emission face when said prism sheet is disposed on said emission face.

It is noted that each of said top portions may have a projecting height constant along said extending direction.

The present invention is also applied to a surface light source device comprising a primary light source, a light guide plate having a minor face providing an incidence face to which light from said primary light source is incident and a major face providing an emission face and prism sheet disposed on said emission face, wherein light is emitted from said emission face with directivity on the way of traveling within said light guide plate after entering into said light guide plate.

Any of prism sheets in accordance with the present invention may be employed in the surface light source device. A display in accordance with the present invention is provided by combining the surface light source device in accordance with the present invention and a displaying member displaying an image illuminated by the surface light source device.

Prism sheets, surface light source devices and displays using the prism sheets have merits as follows.

(1) Even if the prism sheet is partially pressed against the emission face of the light guide plate strongly by a LCD panel or the like and yield-deformation arises at tip portions of prismatic projection rows, size of close contact part hardly becomes large because a plurality of fine projections (the first feature) or a plurality of top portions (the second feature) formed by diverging of the tip portions are provided in the vicinity of the tip portions.

In other words, close contact arises at a plurality of locations separated from each other. Therefore conspicuous white points (point-like abnormal emission) is prevented. As a result, an improved illumination quality or displaying quality or is obtained.

(2) Light input and direction conversion into directions near to a normal direction by inner reflection following thereto are realized effectively because of combination of steep slope (first slope) for light input and gentle slope (second slope) for light inner reflection.

As a result, the surface light source device provides an improved brightness or the display provides a bright image.

(3) Designing and producing of light guide plates having emission directivity becomes easy because reduction in illumination quality are prevented from being caused by white points only by devising configuration of prismatic projection rows of a prism sheet.

### BRIEF DESCRIPTION OF DRAWINGS

FIG. 1 is an exploded perspective view of a surface light source device and a display employing the same of a first embodiment in accordance with the present invention;

FIG. 2a is a cross section view (longitudinal section view) along A-A in FIG. 1;

FIG. 2b is a partially enlarged view of a prism sheet employed in the first embodiment;

FIG. 2c is a partially enlarged view of a prismatic projection of the prism sheet shown in FIG. 2b;

FIG. 3a illustrates a first modification of a prismatic projection

FIG. 3b illustrates a second modification of a prismatic projection

FIG. 3c illustrates a third modification of a prismatic projection

FIG. 4 gives a concrete example of prismatic projection shown in FIG. 2c;

FIG. 5a is a table showing brightness for each prismatic projection;

FIG. 5b illustrates a symmetric prismatic projection;

FIG. 5c illustrates a asymmetric prismatic projection;

FIG. 5d illustrates a prismatic projection of INVENTED ARTICLE 1;

FIG. 5e illustrates a prismatic projection of INVENTED ARTICLE 2;

FIG. 6a is an enlarged view of a symmetric prismatic projection employable in a second embodiment of the present invention;

FIG. 6b is an enlarged view of an asymmetric prismatic projection employable in a second embodiment of the present invention;

FIG. 7a illustrates distortion of a symmetric prismatic projection;

FIG. 7b illustrates distortion of an asymmetric prismatic projection;

FIG. 8 is an exploded perspective view of a surface light source device in accordance with Prior Art 1;

FIG. 9 is an exploded perspective view of a surface light source device in accordance with Prior Art 2;

FIG. 10 is a perspective view of a prism sheet in accordance with Prior Art 3;

FIG. 11a is a longitudinal cross section view of a surface light source device in accordance with Prior Art 4;

FIG. 11b is a partially enlarged view of a prism sheet employed in the surface light source device shown in FIG. 11a; and

FIG. 11c is a partially enlarged view of an emission face of a light guide plate employed in the surface light source device shown in FIG. 11a.

### EMBODIMENT

### First Embodiment

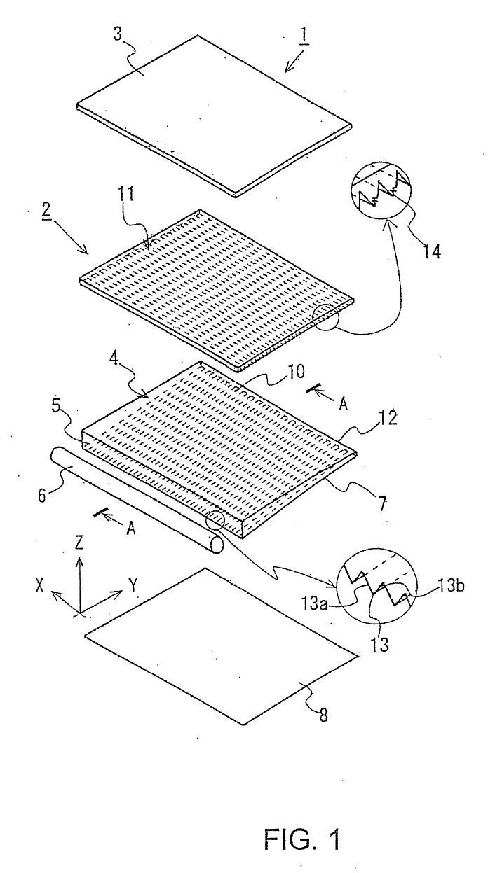

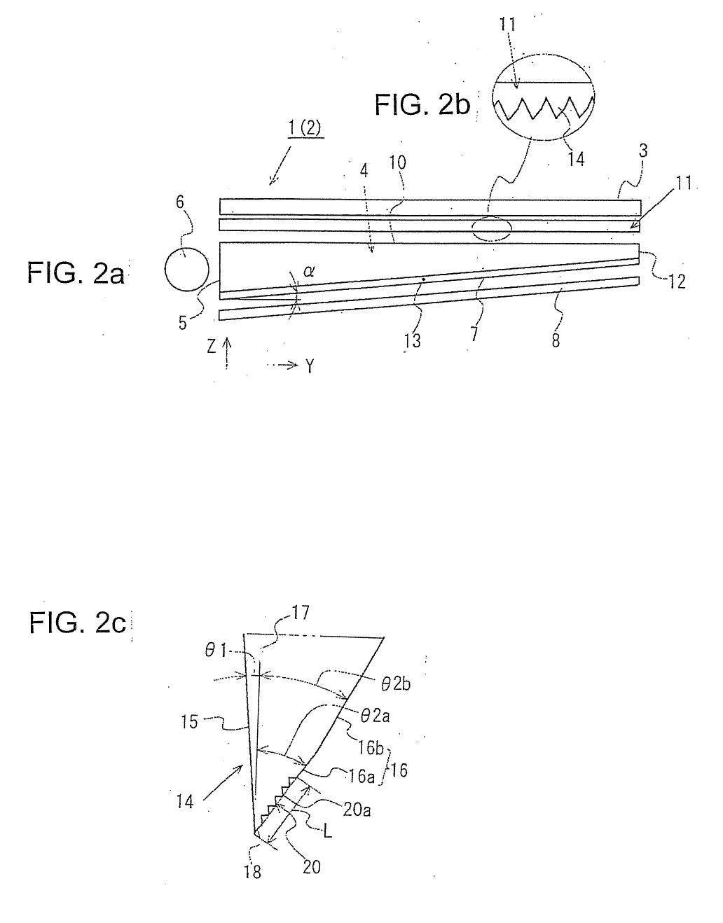

FIG. 1 and FIGS. 2a to 2c illustrate display 1 of the first embodiment. FIG. 1 give an exploded perspective view of display 1 and FIG. 2a is a cross section view (longitudinal section view) along A-A in FIG. 1. FIG. 2b is a partially enlarged view of a prism sheet employed in the first embodiment and FIG. 2c is a partially enlarged view of a prismatic projection of the prism sheet shown in FIG. 2b. Display 1 has surface light source device 2 illuminating LCD panel 3. LCD panel 3 is an example of displaying member).

Surface light source device 2 has light guide plate 4, fluorescent lamp (primary light source) 6 disposed opposite to incidence face 5 provided by a minor face (side face) of light guide plate 4, reflection member 8 disposed along a back face 7 provided by a major face of light guide plate 4 and prism sheet 11 disposed along emission face 10 provided by another major face of light guide pl.

Light from fluorescent lamp 6 propagates within light guide plate 4 after entering into light guide plate 4 through incidence face 5, becoming inner propagation light. When inner propagation light is inner-incident to emission face 10, light components thereof having inner incidence angles not greater than a critical angle are emitted through emission face 10. As known well, this emission light has a preferential propagation direction (main travelling direction) which is inclined forward (i.e. inclined away from incidence face 5) by several ten degrees with respect to a normal direction of emission face 10.

This is so-called “emission directivity” with which emission light from emission face 10 is provided. In other words, “oblique emission light” is emitted from emission face 10 acceding to this emission directivity. This oblique emission light is deflected (redirected) by prism sheet 11 as to come near to the foresaid normal direction.

Light guide plate 4 is made of a light permeable material such as polymethyl methacrylate (PMMA), polycarbonate (PC) or cycloolefin-type resin. As shown in FIGS. 1 and 2, light guide plate 4 has a plan shape generally rectangular, getting thinner according to an increasing distance from incidence face 5 (i.e. toward +Y-direction). For example, back face 7 may be inclined at a predetermined inclination angle α with respect to emission face 10 to decrease gradually in thickness. In other words, light guide plate 4 has a wedge-like cross section in a plane perpendicular to incidence face 5.

As known well, such thickness gradient causes inner propagation light travelling from incidence face 5 toward distal side end face 12 opposite thereto to decrease in inner incidence angle with respect to emission face 10 at every reflection by inclined back face 7. As a result, emission intensity of emission face 10 is prevented from falling in a part far from incidence face 5.

Back face 7 of light guide plate 4 is provided with many prismatic projection rows (emission directivity giving means) 13 running in a direction generally perpendicular to incidence face 5. Prismatic projection rows 13 are formed repeatedly regarding a longitudinal direction of incidence face 5 (i.e. ±X-direction). Each prismatic projection row 13 provides a triangle-like cross section in a plane parallel to incidence face 5, while running from incidence face 5 to distal side end face 12 across light guide plate 4.

Each prismatic projection row 13 has a pair of slopes 13a and 13b at which a remarkable proportion of inner reflection light is reflected and redirected. This direction modification causes travelling directions of light after inner reflection to be near to a YZ-plane passing an inner reflection point (See FIG. 1). This direction modification promotes emission from emission face 10.

It is noted that prismatic projection rows like the above-described prismatic projection rows 13 running in a direction perpendicular to incidence face 5 may be on emission face 10 instead of, or in addition to, prismatic projection rows 13 formed on back face 7. Alternatively, back face 7 and/or emission face 10 may be roughened to a degree such that emission directivity of emission face 10 is maintained in a desirable range.

Further alternatively, back face 7 and/or emission face 10 may be provided with emission promotion pattern such that emission directivity of emission face 10 is maintained in a desirable range. Emission promotion pattern may be provided by projections or recesses like hemispheres, pyramids or cones.

General saying, preferential propagation direction is maintained as to be inclined forward (i.e. inclined away from incidence face 5) by several ten degrees with respect to a normal direction of emission face 10 although some changes depending on formation state of prismatic projection rows or emission promotion pattern on back face 7 and/or emission face 10 arise.

Prism sheet 11 is a film-like member made of light permeable plastic material (such as polyethylene terephthalate (PET), PMMA or PC).

As shown in FIGS. 1 and 2, prism sheet 11 has a plan shape and size which are generally the same as those of emission face 10. Prism sheet 11 has an inner face (face of light input side) directed emission face 10 and outer face (face of light output side) directed oppositely. In FIGS. 1 and 2, the inner face is a lower face and outer face is an upper face.

Many prismatic projection rows 14 are formed running in a direction (±X-direction) generally parallel to incidence face 5 on the inner face. In other words, many prismatic projection rows 14 are formed repeatedly regarding in a direction (±Y-direction) generally perpendicular to incidence face 5.

Each prismatic projection row 14 has first slope 15 and second slope 16 which provide a triangle-like cross section in a plane perpendicular to both incidence face 5 and emission face 10. Comparing first slope 15 and second slope 16 of each prismatic projection rows 14, first slope 15 is located nearer to incidence face 5 than second slope 16. In addition, Comparing inclination of first slope 15 and that of second slope 16, the former is steeper than the latter. In other words, it can be said that first slopes 15 are “steep slopes” and second slopes 16 are “gentle slopes”.

However, it should be noted that second slope 16 has inclination which is not constant overall in this embodiment, consisting of tip-side-slope-portion 16a making angle θ 2 a with respect to normal 17 of emission face 10 and root-side-slope-portion 16b making angle θ 2 b with respect to normal 17, θ 2 a being greater than θ 2 b. On the other hand, first slope 15 has a constant inclination which makes angle α 1 with respect to normal 17 of emission face 10.

After all, there is a relation as illustrated in FIG. 2c, θ 2 a>θ 2 b>θ 1. As described previously, since emission light from emission face 10 is inclined forward (i.e. inclined away from incidence face 5) by several ten degrees with respect to a direction of normal 17, almost all of the emission light is incident to first slopes 15. Accordingly, first slope 15 can be called “light input surface”.

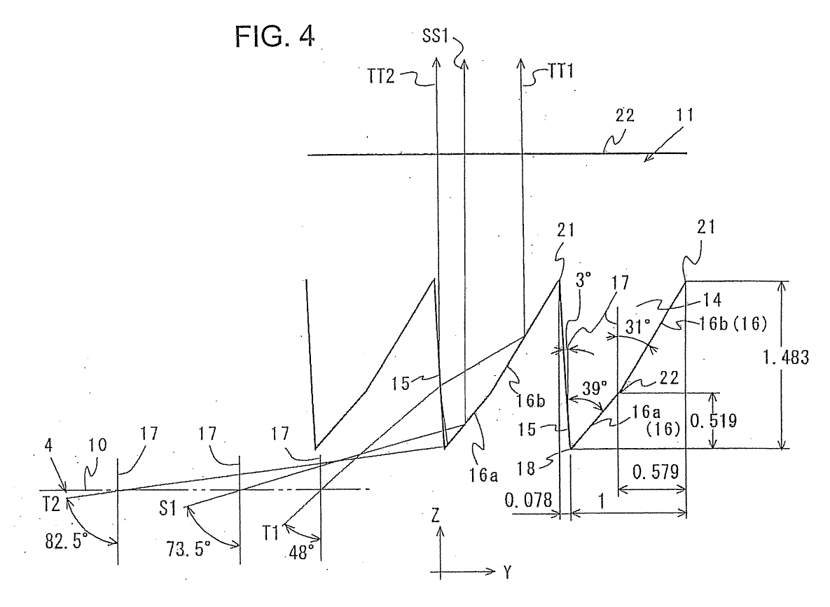

As illustrated in FIG. 4, light having entered into prismatic projection row 14 through first slope 15 is inner-incident to second slope 16, being redirected (direction-converted) by inner reflection as to have a travelling direction which is near to a direction of normal 17 in an imaginary plane perpendicular to both incidence face 5 and emission face 10. Accordingly, second slope 16 can be called “inner reflection surface”.

Thus inner-reflected and redirected light is outputted from the outer face of prism sheet 11, being supplied to LCD panel 3. It is noted that such direction modifying operation (deflection operation) of prism sheet has been known well.

An important matter is that uneven portion 20 is formed within a predetermined vicinity range (L) of tip 18 of tip-side-slope-portion 16a. It is noted, however, that uneven portion 20 formed on second slope 16 is illustration-omitted in FIG. 4. In addition, it is also noted that a practical example of “vicinity range of tip 18” is a range corresponding to “distance not greater than 10μ from tip 18”, preferably, “distance not greater than 7μ from tip 18”.

As shown in FIG. 2c, uneven portion 20 is provided with a plurality of ridge-like fine projections 20a. Fine projections 20a may be provided, for example, by forming fine recesses (grooves) each of which has a triangle-like cross section repeatedly at predetermined intervals.

Each ridge-like fine projection 20a runs along a longitudinal direction of tip-side-slope-portion 16a (i.e. along a direction perpendicular to paper surface in FIG. 2c), keeping a uniform (constant) height over the whole length.

Prism sheet 11 is disposed on emission face 10, being interposed between LCD panel 3 and emission face 10. Therefore, as previously described, force tends to be applied to prism sheet 11 so that the inner face of prism sheet 11 is pressed against emission face 10. If this force is strong, tip portions of prismatic projection rows 14 are subject to deformation (yielding). This deformation (yielding) occurs so that second slope 16 gets nearer to emission face 10 as shown in FIG. 7b (deformation goes from real line position to dotted-line position, then resulting in yielding), since first slope 15 is steep and second slope is gentle.

As a result, a plurality of fine projections 20a of second slope 16 shown in FIG. 2c abut on emission face 10. This causes external force pressing prism sheet 11 against emission face 10 to be dispersed by the fine projections 20a. Further to this, external force is applied as to uniformly distributed within a force-applied-range along a longitudinal direction of prismatic projection row 14 because each fine projection 20a is formed like a ridge having a constant height along the longitudinal direction.

Therefore each fine projection 20a of prism sheet 11 is subject to a smaller degree of yielding (i.e. quantity of crushing) as compared with prismatic projection row 210 of Prior Art 3 (FIG. 10). Thus prismatic projection rows 14 and emission face 10 have a plurality of close contact parts separately distributed. In addition, conspicuous white points are prevented from appearing because individual close contact parts give small sizes.

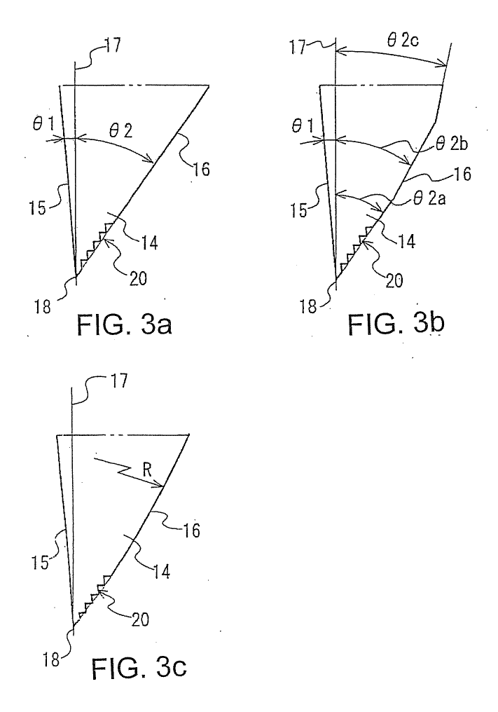

It is noted that prismatic projection row 14 may be modified as to have a cross section differently configurated as compared with that shown in FIG. 2c. FIGS. 3a to 3c show first to third modifications of prismatic projection configuration.

According to the first modification (FIG. 3a), second slope 16 has a constant inclination angle. That is, a constant angle θ 2 is made by normal 17 and second slope 16. Second slope 16 has uneven portion 20 like uneven portion 20 shown in FIG. 2c in the vicinity of tip 18. Such second slope 16 inclined at a uniform inclination angle make designing of apex angle of prism sheet 11 and manufacturing of prism sheet 11 easy.

According to the second modification (FIG. 3b), inclination of second slope 16 of prismatic projection row 14 varies stepwise as to three inclination angles (θ 2 a>θ 2 b>θ 2 c). Instead, inclination of second slope 16 may vary stepwise as to four inclination angles. In such cases, inclination angles of second slope 16 are designed as to get smaller from tip 18 toward root portion (i.e. upper side in FIG. 3b). Further, second slope 16 has uneven portion 20 like uneven portion 20 shown in FIG. 2c on the side of tip 18.

According to the third modification (FIG. 3c), second slope 16 of prismatic projection row 14 gives an arc-like configuration (with radius of curvature R) tangent line of which makes a changing angle with respect to normal 17 so that the changing angle gets smaller away from tip 18 toward a root portion. Second slope 16 has uneven portion 20 like uneven portion 20 shown in FIG. 2c In the vicinity of tip 18.

Second slope 16 as shown in FIG. 3b or FIG. 3c is advantageous for deflecting reflection light produced there to directions near to a normal direction.

Merits like those obtained in foresaid embodiment are also obtained in cases where the above-described modifications are employed. That is, even if force is applied to prism sheet 11 so that the inner face of prism sheet 11 is pressed against emission face 10 and yielding occurs at tip 18, uneven portion 20 (a plurality of fine projection 20a) of second slope 16 abuts on emission face 10.

This causes pressing force to be scattered, with the result prismatic projection rows 14 and emission face 10 give a plurality of close contact parts distributed separately. In addition, individual close contact parts of prismatic projection rows 14 and emission face 10 give small sizes. Thus conspicuous white points are prevented from appearing.

It is noted that ridge-like fine prismatic projections adjacent to each other may have the same height or different heights. Projections providing uneven portion 20 may have shapes other than ridge-like fine prismatic projections of a constant height.

For example, each of the projections may has a dome-like shape. It is noted that “dome-like shape” is defined as to include hemisphere-like shape and tapered shape having non-sharp top portion.

Such independent projections may be formed within a predetermined vicinity range (L) of tip 18 of tip-side-slope-portion 16a at random intervals along a described parallel to incidence face 5 (i.e. in a direction perpendicular to paper surface in FIG. 2c). Height of independent projections may be constant or not. For example, random height is employable.

Even if such modifications are employed, second slope 16 bent down as to get closer to emission face 10 as shown in FIG. 7b on being applied of pressing external force, close contact parts are generated separately regarding both in a direction of predetermined range L in FIG. 2 and in another direction perpendicular thereto (i.e. direction perpendicular to paper surface in FIG. 2c). Therefore individual close contact parts give small sizes, thereby preventing conspicuous white points from appearing. It is noted that projection height preferably falls within a range from 0.1˜50 μm.

Further, if a plurality of independent projections (i.e. non-ridge-like projections) are formed in predetermined range L, they are formed preferably at an appropriate density along a longitudinal direction of prismatic projection row 14 (i.e. ±X-direction). Concretely saying, it is preferable that at least one projection is formed per 0.5 mm along ±X-direction.

Next, a simple description on light reflection member 8 is as follows. Light reflection member 8 is a well-known member made of, for example, PET-sheet having a good reflectivity or a resin-sheet provided with a metal layer having a good reflectivity such as aluminum. Plan shape and size of light reflection member 8 are generally the same as those of back face 7 of light guide plate 4 as shown in FIGS. 1 and 2. Light reflection member 8 functions as to return light leaked through back face 7 by reflection into light guide plate 4.

Light reflection member 8 may be omitted in a case where housing (not shown) accommodating members including light guide plate 4 has a light reflective inner surface acting instead of light reflection member 8. A reflection surface (a surface directed to back face 7) of light reflection member 8 may have scattering-reflectivity or mirror-surface-like-reflectivity.

It is further noted that this embodiment has another merit. That is, according to this embodiment, reduction in illumination quality is prevented from being caused by white points only by devising configuration of prismatic projection rows 14 of a prism sheet 11. Therefore specific devising is not required to applied to light guide plate 4 having emission directivity in order to realize the above aim. As a result, designing and producing of light guide plate 4 becomes easy.

### Second Embodiment

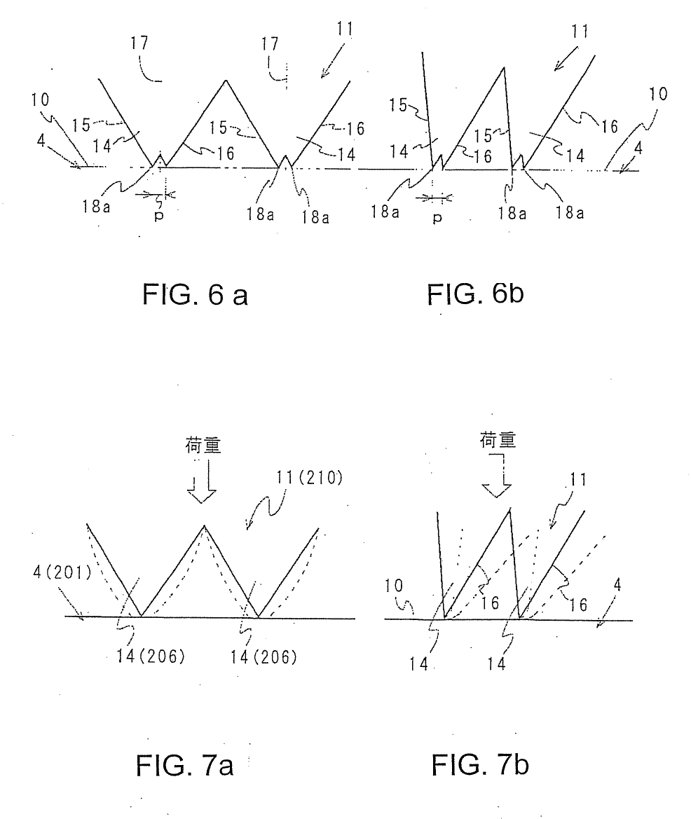

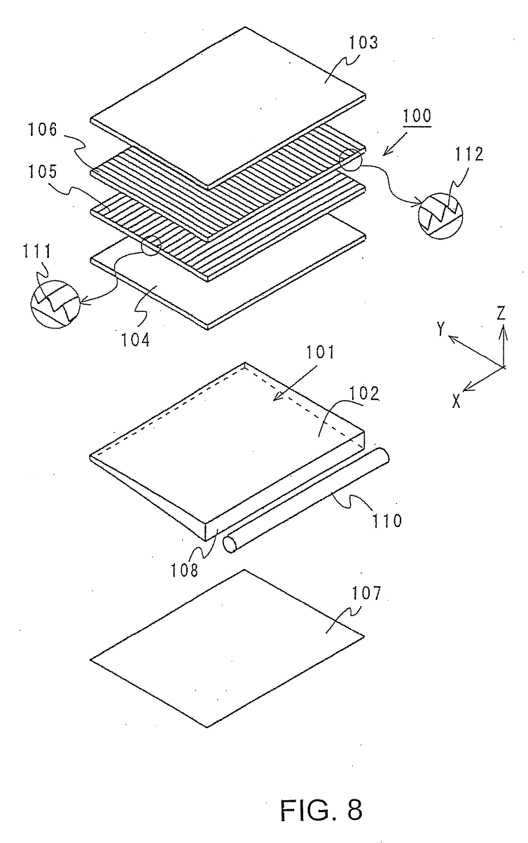

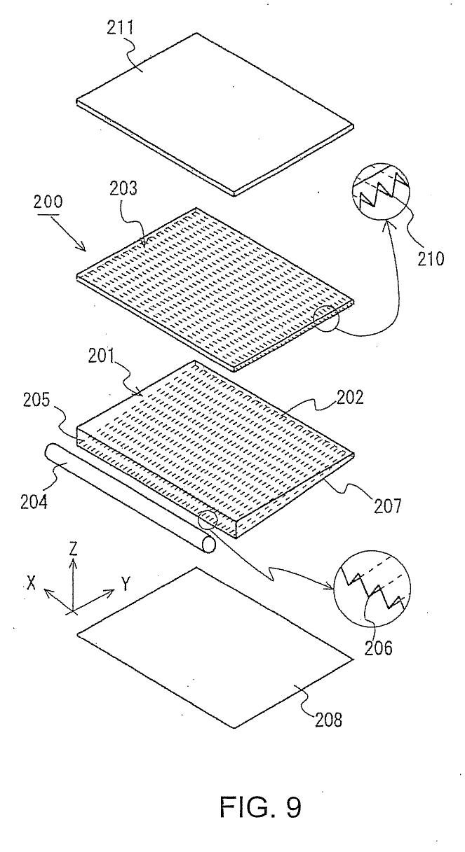

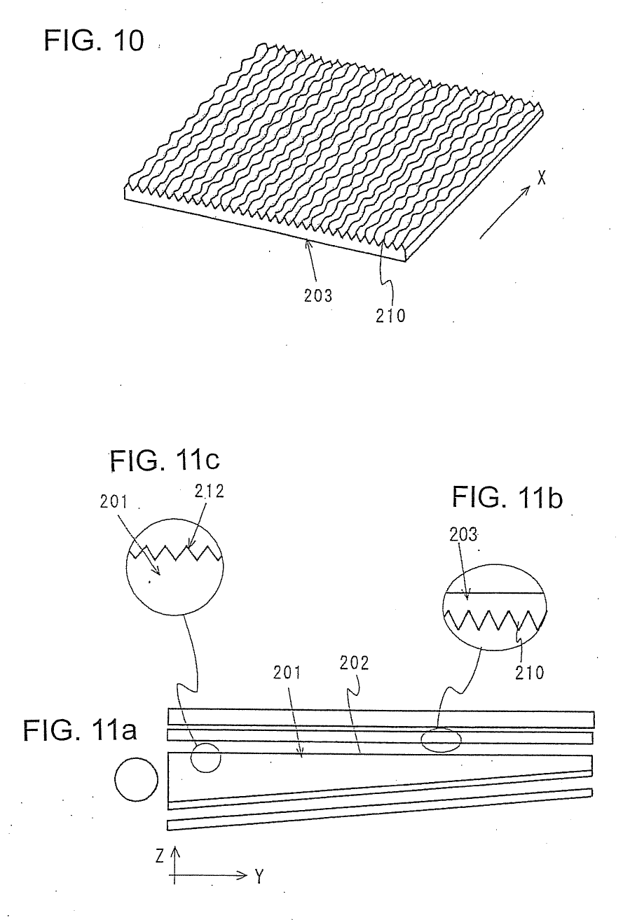

FIGS. 6a and 6b are enlarged cross section views of prismatic projections (two examples) of prism sheets 11 employed in the second embodiment of the present invention.

Prismatic projection row 14 shown in FIG. 6a has first slope 15 and second slope 16 which are configured symmetrically with respect to normal 17. Prismatic projection row 14 has a tip which is diverged as to have two top portions 18a. Top portions 18a are located as to be shifted sideways mutually at pitch (p).

Each top portion 18a is configured symmetrically with respect to normal 17. Further, each top portion 18a has a uniform height along a longitudinal direction of prismatic projection row 14 (i.e. direction perpendicular to paper surface in FIG. 6a). Further two top portions 18a have a height (projecting height) equal to each other. Thus both top portions 18 abut on emission face 10 uniformly along the longitudinal direction of prismatic projection row 14.

On the other hand, prismatic projection row 14 shown in FIG. 6b is such that a tip of prismatic projection row 14 as shown FIG. 3a is diverged as to have two top portions 18a instead of forming uneven portion 20 on second slope 16. That is, first slope 15 and second slope 16 are configured asymmetrically with respect to normal 17.

Top portions 18a are located as to be shifted sideways mutually at pitch (p). Each top portion 18a is configured symmetrically with respect to normal 17. Further, each top portion 18a has a uniform height along a longitudinal direction of prismatic projection row 14 (i.e. direction perpendicular to paper surface in FIG. 6a). Further two top portions 18a have a height (projecting height) equal to each other. Thus both top portions 18 abut on emission face 10 uniformly along the longitudinal direction of prismatic projection row 14.

According to the above-described second embodiment, two top portions 18a of prism sheet 11 abut on emission face 10, causing external force pressing prism sheet 11 against emission face 10 to be dispersed by two top portions 18a. Besides, each top portion 18a external force is applied uniformly along a longitudinal direction of prismatic projection row 14 because each top portion 18a has a constant height along the longitudinal direction.

Therefore, even if prism sheet 11 is partially pinch-pressed between light guide plate 4 and LCD panel 3, each top portions 18a of prism sheet 11 is subject to a smaller quantity of crushing (degree of yielding) as compared with prismatic projection row 210 of Prior Art 3 shown As a result, prismatic projection rows 14 and emission face 10 have close contact parts separately distributed. In addition, conspicuous white points are prevented from appearing because individual close contact parts give small sizes.

It is noted that prismatic projection rows will be crashed by external force (load) as indicated by dotted line and a large area part will be stuck to emission face 10 of light guide plate 4, generating white points and reducing illumination quality, if prismatic projection row 14 has a tip without being provided with top portions 18a formed by being diverged, as shown in FIG. 7b.

However, if uneven portion 20 is formed on second slope 16 in a way as described in the first embodiment description, tips without divergence can avoid such undesirable situation. It is noted that combination of the first and second embodiments are employable. That is, uneven portion 20 may be formed on second slope 16 in a previously described way while tips of prismatic projection rows 14 are diverged as to have a plurality of top portions.

Surface light source device 2 employing prism sheet 11 according to the second embodiment and display 1 comprising surface light source device 2 are capable of avoiding illumination quality reduction from being caused by white points in generally the same way as the first embodiment, enabling high-quality bright displaying to be performed.

As a additional description, an example of concrete example of data for prism sheet 11 is given as follows. Referring to FIG. 4 again, data for prism sheet 11 employed in the first embodiment are shown. It is noted that uneven portion 20 on second slope 16 is not illustrated as already referred to.

If Y-direction size from tip 18 of prismatic projection row 14 to root 21 of second slope 16 is defined a 1 in FIG. 4, other sizes are below.

(i) Z-direction size from tip 18 of prismatic projection row 14 to root 21 of second slope 16=1.483

(ii) Z-direction size from tip 18 of prismatic projection row 14 to boundary portion 22 between tip-side-slope-portion 16a and root-side-slope-portion 16b=0.519

(iv) Y-direction size from boundary portion 22 between tip-side-slope-portion 16a and root-side-slope-portion 16b to root 21 of prismatic projection row 14=0.579

(iv) −Y-direction size from tip 18 of prismatic projection row 14 to root 21 of first slope 15=0.078

Angles are as follows.

(v) Angle (θ 1) made by first slope 15 and normal 17=3°

(vi) Angle (θ 2a) made by tip-side-slope-portion 16a of second slope 16 and normal=39°

(vii) Angle (θ 2b) made by root-side-slope-portion 16b of second slope 16 and normal 17=31°

Provided that an angle (simply called “emission angle” hereafter) made by emission light T1 from light guide plate 4 and normal 17 is 48° as a condition in FIG. 4.

Under this condition, light T1 having entered into prismatic projection row 14 is reflected at root-side-slope-portion 16b of second slope 16, then reflection light T1 is emitted from output face (emission face) 22 of prism sheet 11 so that state of being deflected as to get near to a normal direction (Z-direction) is maintained.

Further provided another condition that emission angle of 73.5°, light S1 emitted from light guide plate 4 is reflected at tip-side-slope-portion 16a of second slope 16 after entering into prismatic projection row 14, then reflection light SS1 is deflected as to get near to a normal direction (Z-direction) and emitted from output face (emission face) 22 of prism sheet 11.

Further provided still another condition that emission angle of 82.5°, light T2 emitted from light guide plate 4 is reflected at tip-side-slope-portion 16a of second slope 16 after entering into prismatic projection row 14, then being reflected again at first slope 15. Thus reflection light TT2 is emitted from output face (emission face) 22 of prism sheet 11 so that state of being deflected as to get near to a normal direction (Z-direction) is maintained.

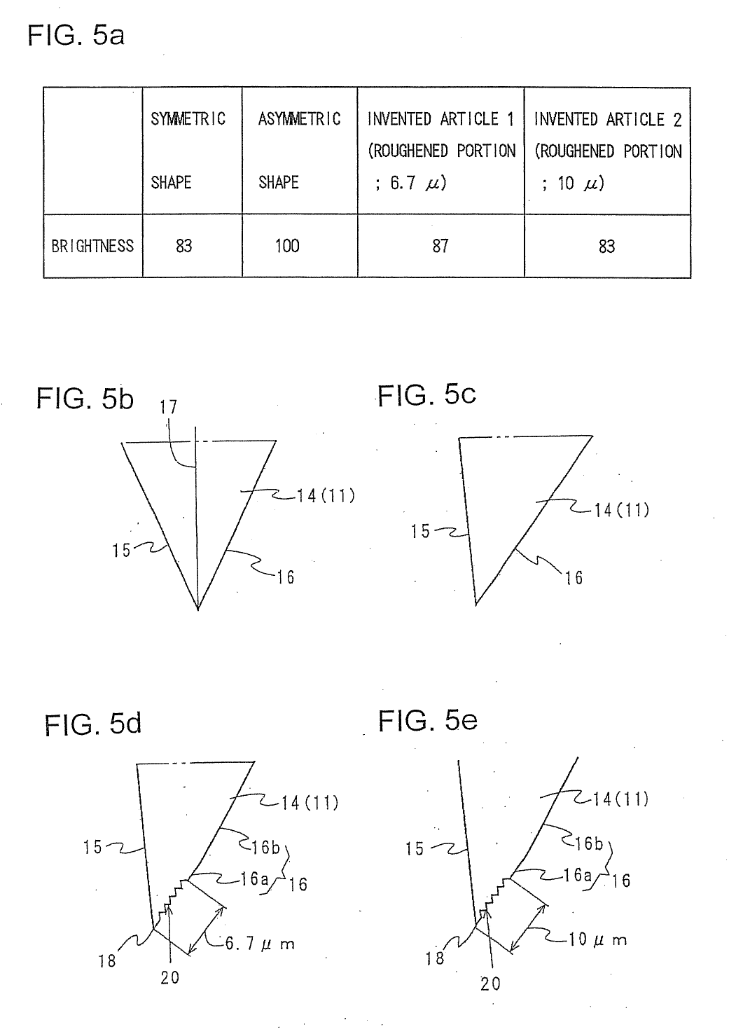

Any way, if uneven portion (roughened surface portion) 20 is formed on second slope 16 of prismatic projection row of prism sheet 11 as described in the first embodiment, some reduction in brightness as compared with cases without uneven portion 20 will occur. However this reduction is slight, which is exemplarily demonstrated by results of emission brightness comparison test as shown in FIG. 5. Items in FIG. 5 are as follows.

SYMMETRIC SHAPE=Prism sheet which is provided with prismatic projection rows 14 having first and second slopes 15, 16 formed symmetrically with respect to a normal as shown in FIG. 5b and has no uneven portion 20 like that shown in FIG. 2c. This does not belong to any embodiment of the present invention.

ASYMMETRIC SHAPE=Prism sheet which is provided with prismatic projection rows 14 having first and second slopes 15, 16 formed asymmetrically with respect to a normal as shown in FIG. 5c and has no uneven portion 20. This does not belong to any embodiment of the present invention.

INVENTED ARTICLE 1=Prism sheet 11 which has prismatic projection rows 14 in which uneven portion 20 is formed within a predetermined range of 6.7 μm, on tip-side-slope-portion 16a, from tip 18, as shown in FIG. 5d.

INVENTED ARTICLE 2=Prism sheet 11 which has prismatic projection rows 14 in which uneven portion 20 is formed within a predetermined range of 10 μm, on tip-side-slope-portion 16a, from tip 18, as shown in FIG. 5e.

It is noted that emission brightness of asymmetric prism sheet 11 is defined as 100 for the sake of normalization. Comparing emission brightness obtained by the respective prism sheets 11, emission brightness obtained by symmetric prism sheets 11 is 83 and that obtained by prism sheet 11 of INVENTED ARTICLE 1 is 87. Further, emission brightness obtained by prism sheet 11 of INVENTED ARTICLE 2 is 83.

In addition, observing test of observing white point generation for the above respective items (SYMMETRIC SHAPE/ASYMMETRIC SHAPE/INVENTED ARTICLE 1/INVENTED ARTICLE 2). That is, pinching-pressure is applied partially after prism sheet 11 is disposed on emission face 10 of light guide plate 4, then light emitted from prism sheet 11 is watched.

It was confirmed that a range from 6.7 μm to 10 μm, given by INVENTED ARTICLE 1 and INVENTED ARTICLE 2 shown in FIG. 5a bring particularly inconspicuous white points. Thus prismatic projection row 14 shown in FIG. 4 can bring particularly well suppressed white points and high emission brightness when a range of formation of uneven portion 20 is from 6.7 μm to 10 μm in distance from tip 18.

1. A prism sheet used for deflect travelling directions of emission light with directivity from an emission face of a light guide plate as to make the travelling directions near to a normal direction of the emission face by being disposed on the emission face, comprising;
an inner face which is directed to said emission face when the prism sheet is disposed on said emission face; and
an outer face directed oppositely to said inner face, wherein
said inner face is provided with a plurality of prismatic projection rows side by side along an extending direction, and each of said prismatic projection rows is provided with a first slope providing an input surface for said emission light and a second slope providing an inner-reflection surface for light inputted from said first slope, thereby providing a triangle-like cross section perpendicular to said extending direction, and,
said first slope makes a first angle with respect to said normal direction in said cross section and said second slope makes a second angle, which is larger than said first angle, with respect to said normal direction in said cross section,
said second slope is provided with a plurality of fine projections in a predetermined range near to a tip at which said second slope meets said first slope.

2. A prism sheet according to claim 1, wherein each of said fine projections has a projecting height falling in a rage from 0.1 to 50 μm.

3. A prism sheet according to claim 1, wherein each of said fine projections is a ridge-like projection extending along said extending direction.

4. A prism sheet according to claim 3, wherein said ridge-like projection is formed of, a prismatic projection which has a projecting height constant along said extending direction and a triangle-like cross section perpendicular to said extending direction.

5. A prism sheet according to claim 1, wherein each of said fine projections is a dome-like projection.

6. A prism sheet according to claim 5, wherein said fine projections have a constant projecting height.

7. A prism sheet used for deflect travelling directions of emission light with directivity from an emission face of a light guide plate as to make the travelling directions near to a normal direction of the emission face by being disposed on the emission face, comprising;
an inner face which is directed to said emission face when the prism sheet is disposed on said emission face; and
an outer face directed oppositely to said inner face, wherein
said inner face is provided with a plurality of prismatic projection rows side by side along an extending direction, and each of said prismatic projection rows is provided with a first slope providing an input surface for said emission light and a second slope providing an inner-reflection surface for light inputted from said first slope, thereby providing a triangle-like cross-section perpendicular to said extending direction, and,
each of said prismatic projection rows diverges at a tip of said triangle-like as to provide a plurality of top portions each of which has a triangle-like cross section perpendicular to said extending direction, thereby causing said top portions to be in contact with said emission face when said prism sheet is disposed on said emission face.

8. A prism sheet according to claim 7, wherein each of said top portions has a projecting height constant along said extending direction.

9. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 1.

10. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 3.

11. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 4.

12. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 5.

13. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 7.

14. A display comprising:
a displaying member displaying an image; and
a surface light source device,
wherein said surface light source device is in accordance with claim 9.

15. A display comprising:
a displaying member displaying an image; and
a surface light source device,
wherein said surface light source device is in accordance with claim 10.

16. A display comprising:
a displaying member displaying an image; and
a surface light source device,
wherein said surface light source device is in accordance with claim 11.

17. A display comprising:
a displaying member displaying an image; and
a surface light source device,
wherein said surface light source device is in accordance with claim 12.

18. A display comprising:
a displaying member displaying an image; and
a surface light source device,
wherein said surface light source device is in accordance with claim 13.

19. A prism sheet according to claim 2, wherein each of said fine projections is a ridge-like projection extending along said extending direction.

20. A prism sheet according to claim 2, wherein each of said fine projections is a dome-like projection.

21. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 3.

22. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 6.

23. A surface light source device comprising:
a primary light source;
a light guide plate having a minor face providing an incidence face to which light from said primary light source is incident and a major face providing an emission face; and
a prism sheet disposed on said emission face,
wherein light is emitted from said emission face with directivity on the way of traveling within said light guide plate after entering into said light guide plate, said prism sheet is in accordance with claim 8.
